(19) United States
(12) Patent Application Publication
(10) Pub. No.: US 2009/0138697 A1
(43) Pub. Date: May 28, 2009

(54) USER AGENT PROVIDING SECURE VoIP COMMUNICATION AND SECURE COMMUNICATION METHOD USING THE SAME

(75) Inventors: Joong Man KIM, Namyangju-si (KR); Hwan Kuk Kim, Seoul (KR); Seok Ung Yoon, Seongnam-si (KR); Chae Tae Im, Seoul (KR); Young Duk Cho, Yongin-si (KR); Yong Geun Won, Seoul (KR); Tai Jin Lee, Seoul (KR); Yoo Jae Won, Yongin-si (KR)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Korea Information Security Agency

(21) Appl. No.: 12/181,582

(22) Filed: Jul. 29, 2008

(30) Foreign Application Priority Data
Nov. 23, 2007 (KR) 10-2007-0120029

(51) Int. Cl. H04L 9/00

(52) U.S. Cl. 713/150

(57) ABSTRACT

Disclosed are a user agent providing secure VoIP communication and a secure communication method using the same. A user agent of the invention has an additional module for providing a secure function as well as a module for providing general communication, thereby supporting the secure communication. In addition, as a secure communication method using the user agent, a signaling security mechanism negotiation method and a media encryption algorithm negotiation method are provided. Hence, it is possible to provide internet telephone users with a secure VoIP communication service.

### CROSS-REFERENCE TO RELATED APPLICATIONS

This application claims all benefits of Korean Patent Application No. 10-2007-0120029 filed on Nov. 23, 2007 in the Korean Intellectual Property Office, the disclosures of which are incorporated herein by reference.

### BACKGROUND

1. Technical Field

The present invention relates to a user agent that provides secure VoIP communication and a secure communication method using the same. A user agent of the present invention has an additional module for providing a secure function as well as a module for providing general communication, thereby supporting the secure communication. In addition, as a secure communication method using the user agent, a signaling security mechanism negotiation method and a media encryption algorithm negotiation method and a spam management method are provided. Hence, it is possible to provide internet telephone users with a secure VoIP communication service.

2. Description of the prior art

As a computer technology has made advances, an application called as web (World Wide Web; WWW) has appeared. Hence, the internet has been universally used, so that an internet telephone having the lower fee for a call is also increasingly used.

An internet telephone system converts a voice signal into a voice data packet, transmits the packet to the other party through the internet established for data exchange between the computers, converts the voice data received from the other party into a voice signal and outputs the voice signal to a user, thereby enabling the voice communication. The internet telephone system is classified into a PC-to-PC way in which all the users making a call use the PC, a PC-to-Phone way in which one user uses the PC and the other user uses a general phone and a Phone-to-Phone way in which both users use a general phone, in accordance with types of terminals that the users use.

In the conventional internet telephone system, the standard VoIP protocol (SIP or H0.323) has been used to all the communications between the respective system constituting elements for controlling a call. In particular, there is a SIP (Session Initiation Protocol) user agent enabling an internet telephone service based on the SIP. However, the conventional user agent has a problem that it provides only a general call function and does not provide a communication security.

### SUMMARY OF THE DISCLOSURE

Accordingly, the present invention has been made to solve the above problems. An object of the invention is to provide a user agent having an additional module for providing a secure function as well as a module for providing general communication, thereby supporting the secure communication.

Another object of the invention is to provide a signaling security mechanism negotiation method and a media encryption algorithm negotiation method as a secure communication method using the user agent.

The present invention relates to a user agent providing secure VoIP communication. The user agent comprises: a user interface that enables a user to operate the user agent to communicate with another user agent; a signaling processing module for controlling a signaling for initiating the communication with the another user agent, which when there is a request for encryption call from a user, determines a signaling security mechanism through negotiations with an external server, encrypts a signaling message in accordance with the determined security mechanism, transmits the encrypted message to the another user agent and receives and analyzes an encrypted signaling message from the another user agent; and a media processing module for supporting secure communication with the another user agent, which when there is a request for encryption call from the signaling processing module, generates an encryption key, determines a media encryption algorithm through negotiations with the another user agent, encrypts a voice packet generated from a voice signal of the user, transmits the encrypted packet to the another user agent and receives and decrypts an encrypted voice packet from the another user agent.

In addition, the invention relates to a secure communication method using the user agent. The method comprises a signaling security mechanism negotiation method and a media encryption algorithm negotiation method.

The signaling security mechanism negotiation method comprises the steps of: (a) generating, at a signaling security mechanism negotiation unit, a negotiation message using a security mechanism supported by the user agent in accordance with a request for encryption call received from a signaling control unit; (b) transmitting, at the signaling security mechanism negotiation unit, the negotiation message to an external server through a signaling message transmitting/receiving unit; (c) analyzing, at the signaling security mechanism negotiation unit, a response message received from the external server through the signaling message transmitting/receiving unit; and (d) negotiating, at the signaling security mechanism negotiation unit, with the external server for a security mechanism common to the external server and the user agent.

The media encryption algorithm negotiation method comprises the steps of: (a) generating, at a media encryption key management and encryption algorithm negotiation unit, an encryption key and a negotiation message using an encryption algorithm supported by the user agent, in accordance with a request for encryption call received from a media control unit; (b) transmitting, at the media encryption key management and encryption algorithm negotiation unit, the encryption key and the negotiation message to a receive-side user agent; (c) analyzing, at the media encryption key management and encryption algorithm negotiation unit, a response message received from the receive-side user agent; and (d) negotiating, at the media encryption key management and encryption algorithm negotiation unit, with the receive-side user agent for an encryption algorithm common to the receive-side user agent.

According to the invention, the user agent has an additional module for providing a secure function as well as a module for providing general communication, thereby supporting the secure communication. In addition, the invention provides a signaling security mechanism negotiation method, a media encryption algorithm negotiation method and a spam management method, thereby enabling an internet telephone user to use the secure VoIP communication service.

### BRIEF DESCRIPTION OF THE DRAWINGS

The above and other objects, features and advantages of the present invention will be more apparent from the following detailed description taken in conjunction with the accompanying drawings, in which:

FIG. 1 shows a structure of a user agent according to an embodiment of the invention;

FIG. 2 is a flow chart showing a process of negotiating for a signaling security mechanism according to an embodiment of the invention;

FIG. 3 is a flow chart showing a process of negotiating for a media encryption algorithm according to an embodiment of the invention; and

FIG. 4 is a flow chart showing a process of managing a spam according to an embodiment of the invention.

### DETAILED DESCRIPTION OF THE INVENTION

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

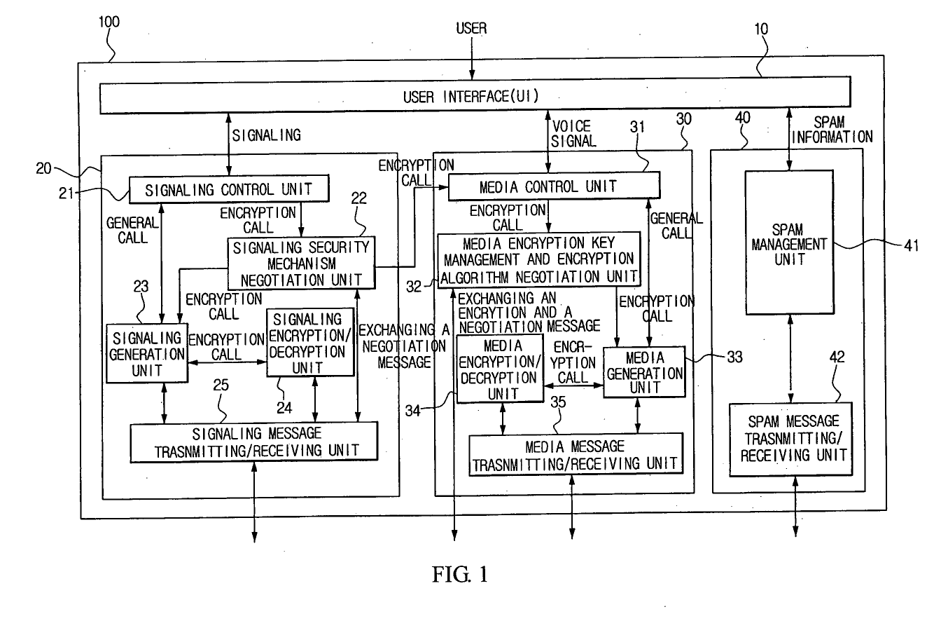

FIG. 1 shows a structure of a user agent according to an embodiment of the invention.

A user agent 100 according to an embodiment of the invention comprises a user interface (UI) 10, a signaling processing module 20, a media processing module 30 and a spam processing module 40.

The user interface 10 is a module that enables a user to operate the user agent 100 to communicate with a receive-side user agent. Preferably, the user interface 10 is implemented as a graphic user interface (GUI) enabling an interaction between a user and the user agent 100 through the graphic.

The signaling processing module 20 is a module that controls a signaling for initiating the communication between the transmit-side and receive-side user agents. When there is a request for encryption call from a user, the signaling processing module 20 determines a signaling security mechanism through negotiations with an external server, encrypts a signaling message in accordance with the determined security mechanism, transmits the encrypted message to the receive-side user agent and receives and analyzes an encrypted signaling message from the receive-side user agent.

To be more specific, the signaling processing module 20 comprises a signaling control unit 21, a signaling security mechanism negotiation unit 22, a signaling generation unit 23, a signaling encryption/decryption unit 24 and a signaling message transmitting/receiving unit 25.

The signaling control unit 21 analyzes a signaling message transmitted and received between the transmit-side and receive-side user agents. For example, when the transmit-side and receive-side user agents communicate with each other on the basis of the SIP (Session Initiation Protocol), the signaling control unit analyzes a SIP message. In addition, when three is a request for encryption call from a user, the signaling control unit requests the signaling security mechanism negotiation unit 22 to negotiate for a security mechanism. For a general call in which there is no request for an encryption call from a user, the signaling control unit requests the signaling generation unit 23 to generate a signaling message.

When a request for security mechanism negotiations is received from the signaling control unit 21, the signaling security mechanism negotiation unit 22 performs the negotiations with an external server (not shown) to determine a signaling security mechanism. To be more specific, after generating a negotiation message using a security mechanism supported by the user agent 100, the signaling security mechanism negotiation unit 22 transmits the negotiation message to the external server through the signaling message transmitting/receiving unit 25. At this time, the security mechanism supported by the user agent 100 includes TLS (Transport Layer Security), S/MIME (Secure Multi-Purpose Internet Mail Extensions) and the like, for example. Then, the signaling security mechanism negotiation unit 22 analyzes a response message received from the external server through the signaling message transmitting/receiving unit 25 to compare with the security mechanism supported by the user agent 100, thereby determining a security mechanism common to the external server and the user agent 100. Then, the signaling security mechanism negotiation unit requests the signaling generation unit 23 to generate a signaling message. At this time, when there are two or more security mechanisms common to the external server and the user agent 100, a security mechanism having a higher priority is determined in accordance with a security policy of the user agent 100.

The signaling generation unit 23 generates a signaling message in accordance with the request for signaling generation received from the signaling control unit 21 or signaling security mechanism negotiation unit 22. In addition, for a general call, the signaling generation unit 23 requests the signaling message transmitting/receiving unit 25 to transmit the signaling message to the receive-side user agent. For an encryption call, the signaling generation unit 23 requests the signaling encryption/decryption unit 24 to encrypt the signaling message. Further, for a general call, the signaling generation unit 23 transmits the signaling message, which is received from the receive-side user agent through the signaling message transmitting/receiving unit 25, to the signaling control unit 21. For an encryption call, the signaling generation unit transmits the signaling message, which is received from the signaling encryption/decryption unit 24, to the signaling control unit 21.

The signaling encryption/decryption unit 24 encrypts the signaling message through the security mechanism negotiated by the signaling security mechanism negotiation unit 22, in accordance with the request for signaling message encryption received from the signaling generation unit 23, and then requests the signaling message transmitting/receiving unit 25 to transmit the encrypted signaling message to the received-side user agent. Meanwhile, when the user agent 100 receives an encrypted signaling message from the receive-side user agent, the signaling encryption/decryption unit 24 decrypts and transmits the encrypted signaling message to the signaling generation unit 23.

The signaling message transmitting/receiving unit 25 transmits a negotiation message to the external server in accordance with the request of the signaling security mechanism negotiation unit 22, receives a response message from the external server and transmits the response message to the signaling security mechanism negotiation unit 22. In addition, the signaling message transmitting/receiving unit transmits the signaling message to the receive-side user agent in accordance with a request of the signaling generation unit 23 or signaling encryption/decryption unit 24. The signaling message transmitting/receiving unit receives the signaling message from the receive-side user agent. Depending on whether the received signaling message is encrypted or not, the signaling transmitting/receiving unit transmits the received signaling message to the signaling generation unit 23 for a general call. For an encryption call, the signaling transmitting/receiving unit transmits the received signaling message to the signaling encryption/decryption unit 24.

The media processing module 30 is a module that supports secure voice communication between the transmit-side and receive-side user agents. When there is a request for encryption call from the signaling processing module 20, the media processing module generates an encryption key, determines a media encryption algorithm through negotiations with the receive-side user agent, encrypts a voice packet generated from a voice signal of the user and transmits the encrypted packet to the receive-side user agent. In addition, the media processing module receives and decrypts the encrypted voice packet from the receive-side user agent, and then provides a voice signal to the user through the user interface 10.

To be more specific, the media processing module 30 comprises a media control unit 31, a media encryption key management and encryption algorithm negotiation unit 32, a media generation unit 33, a media encryption/decryption unit 34 and a media message transmitting/receiving unit 35.

The media control unit 31 analyzes the voice signal of the user received from the user interface 10. Depending on whether there is a request for encryption call from the signaling processing module 20, when there is a request for encryption call, the media control unit requests the media encryption key management and encryption algorithm negotiation unit 32 to generate an encryption key and to negotiate for an encryption algorithm. For a general call having no request for encryption call, the media control unit requests the media generation unit 33 to generate a media message. In addition, the media control unit provides the voice signal, which is received from the receive-side user agent and decrypted, to the user through the user interface 10.

When the media encryption key management and encryption algorithm negotiation unit 32 receives the request for encryption key generation and encryption algorithm negotiation from the media control unit 31, it progresses an encryption key exchange and negotiation process with the receive-side user agent (not shown) after generation of an encryption key, thereby determining an encryption algorithm. To be more specific, after generation of an encryption key, the media encryption key management and encryption algorithm negotiation unit 32 generates a negotiation message using an encryption algorithm supported by the user agent 100 and transmits the negotiation message to the receive-side user agent. At this time, the encryption algorithm supported by the user agent 100 includes AES (Advanced Encryption Standard) or SEED, for example. Then, the media encryption key management and encryption algorithm negotiation unit 32 analyzes a response message received from the receive-side user agent to compare with the encryption algorithm supported by the user agent 100, thereby determining an encryption algorithm common to the receive-side user agent and the transmit-side user agent 100. Then, the media encryption key management and encryption algorithm negotiation unit requests the media generation unit 23 to generate a media message. At this time, when there are two or more encryption algorithms common to the receive-side user agent and the transmit-side user agent, an encryption algorithm having a higher priority is determined in accordance with a security policy of the user agent 100.

The media generation unit 33 generates a media message, i.e., voice packet from the voice signal of the user received at the media control unit 31, in accordance with the request for media generation received from the media control unit 31 or the media encryption key management and encryption algorithm negotiation unit 32. In addition, for a general call, the media generation unit 33 requests the media message transmitting/receiving unit 35 to transmit the voice packet to the receive-side user agent. For an encryption call, the media generation unit requests the medal encryption/decryption unit 34 to encrypt the voice packet. Further, for a general call, the media generation unit transmits the voice packet, which is received from the receive-side user agent through the media message transmitting/receiving unit 35, to the media control unit 31. For an encryption call, the media generation unit transmits the voice packet, which is received from the media encryption/decryption unit 34, to the media control unit 31.

The media encryption/decryption unit 34 encrypts the voice packet through the encryption algorithm determined by the media encryption key management and encryption algorithm negotiation unit 32, in accordance with the request for voice packet encryption received from the media generation unit 33, and then requests the media message transmitting/receiving unit 35 to transmit the encrypted voice packet to the received-side user agent. Meanwhile, when the user agent 100 receives the encrypted voice packet from the receive-side user agent, the media encryption/decryption unit 34 decrypts the encrypted voice packet and then transmits the decrypted packet to the media generation unit 33.

The media transmitting/receiving unit 35 transmits a media message, i.e. voice packet or encrypted voice packet to the receive-side user agent in accordance with the request from the media generation unit 33 or the media encryption/decryption unit 34. In addition, the media message transmitting/receiving unit receives a media message, i.e., voice packet or encrypted voice packet from the receive-side user agent. For a voice packet, the media transmitting/receiving unit transmits the received media message to the media generation unit 33. For an encrypted voice packet, the media transmitting/receiving unit transmits the received media message to the media encryption/decryption unit 34.

The spam processing module 40 is a module that manages a blacklist/whitelist so as to block a spam message or call received by the user agent 100 and blocks call reception at any time zone set by a user.

To be more specific, the spam processing module 40 comprises a spam management unit 41 and a spam message transmitting/receiving unit 42.

The spam management unit 41 manages a blacklist/whitelist set by a user through the user interface 10. For example, when a message or call from any transmitter, which is classified as a blacklist by a user, is received through the spam message transmitting/receiving unit 42, the spam management unit 41 discourages the user agent 100 from giving an alarm for the received call and immediately blocks the call. The alarm may be a bell sound or vibration, for example. Then, the spam management unit generates a log for the call so that the user can check the call reception and the blocking. To the contrary, when a message or call from any transmitter, which is classified as a whitelist by a user, is received, the spam management unit 41 encourages the user agent 100 to give an alarm for the call, thereby notifying the user of the call reception.

In addition, the spam management unit 41 temporarily blocks call reception at any time zone set by a user through the user interface 10. For example, when a user sets a specific time zone, for example from 12 P.M. to 5 A.M., as a reception blocking mode, the spam management unit 44 discourages the user agent 100 from giving an alarm for a call received during the set time zone, immediately blocks the call and generates a log for the call so that the user can check the call reception and the blocking.

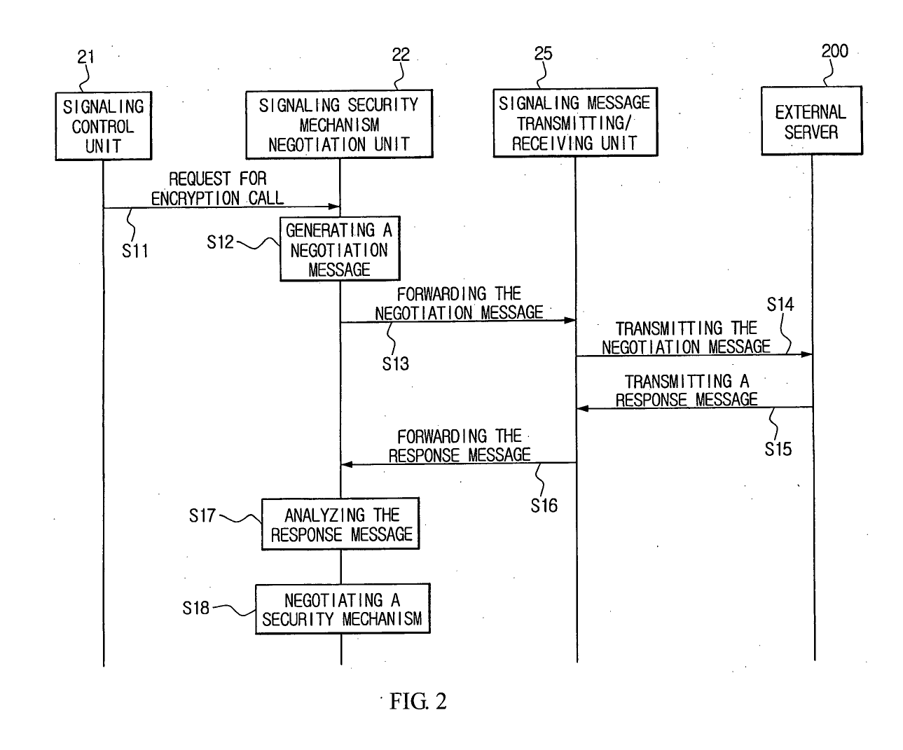

The following describes a secure communication method using a user agent according to the invention with reference to FIGS. 2 to 4.

FIG. 2 is a flow chart showing a process of negotiating for a signaling security mechanism according to an embodiment of the invention.

First, when the signaling security mechanism negotiation unit 22 receives a request for encryption call, i.e., a request for security mechanism negotiations from the signaling control unit 21 (S11), it generates a negotiation message using the security mechanism supported by the user agent 100 (S12). Then, the signaling security mechanism negotiation unit transmits the negotiation message to the external server 200 through the signaling message transmitting/receiving unit 25 (S13 and S14).

Then, the signaling security mechanism negotiation unit 22 receives a response message from the external server 200 through the signaling message transmitting/receiving unit 25 (S15 and S16) and analyzes the response message (S17). At this time, the signaling security mechanism negotiation unit 22 compares the security mechanism supported by the external server 200 with the security mechanism supported by the user agent 100, thereby negotiating with the external server 200 for a security mechanism common to the external server 200 and the user agent 100 (S18). At this time, when there are two or more security mechanisms common to the external server 200 and the user agent 100, a security mechanism having a higher priority is determined in accordance with a security policy of the user agent 100.

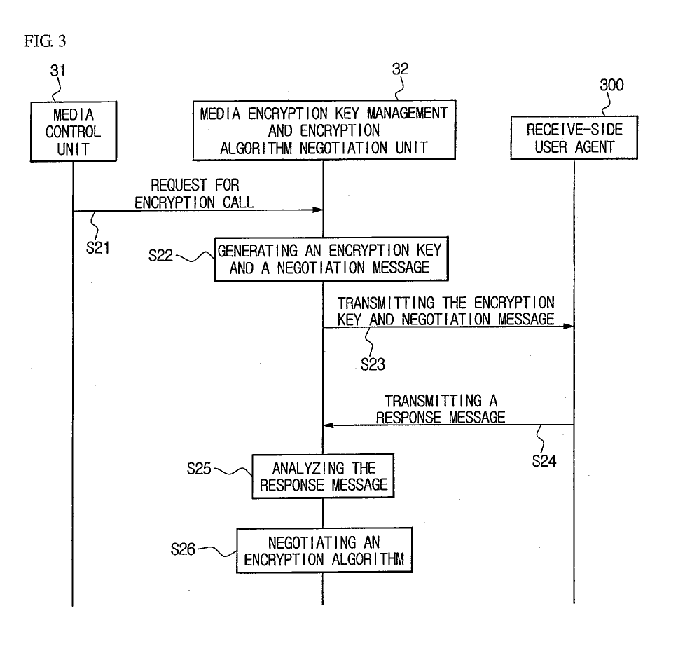

FIG. 3 is a flow chart showing a process of negotiating for a media encryption algorithm according to an embodiment of the invention.

First, when the media encryption key management and encryption algorithm negotiation unit 32 receives a request for encryption call, i.e., a request for encryption key generation and encryption algorithm negotiations from the media control unit 31 (S21), it generates an encryption key and a negotiation message using the encryption algorithm supported by the user agent 100 (S22). Then, the media encryption key management and encryption algorithm negotiation unit transmits the encryption key and the negotiation message to the receive-side user agent 300 (S23).

Then, the media encryption key management and encryption algorithm negotiation unit 32 receives a response message from the receive-side user agent 300 (S24) and analyzes the response message (S25). At this time, the media encryption key management and encryption algorithm negotiation unit 32 compares the encryption algorithm supported by the receive-side user agent 300 with the encryption algorithm supported by the user agent 100, thereby negotiating with the receive-side user agent for an encryption algorithm common to the receive-side user agent 300 and the transmit-side user agent 100. At this time, when there are two or more encryption algorithms common to the transmit-side and receive-side user agents 100 and 300, a security mechanism having a higher priority is determined in accordance with a security policy of the user agent 100.

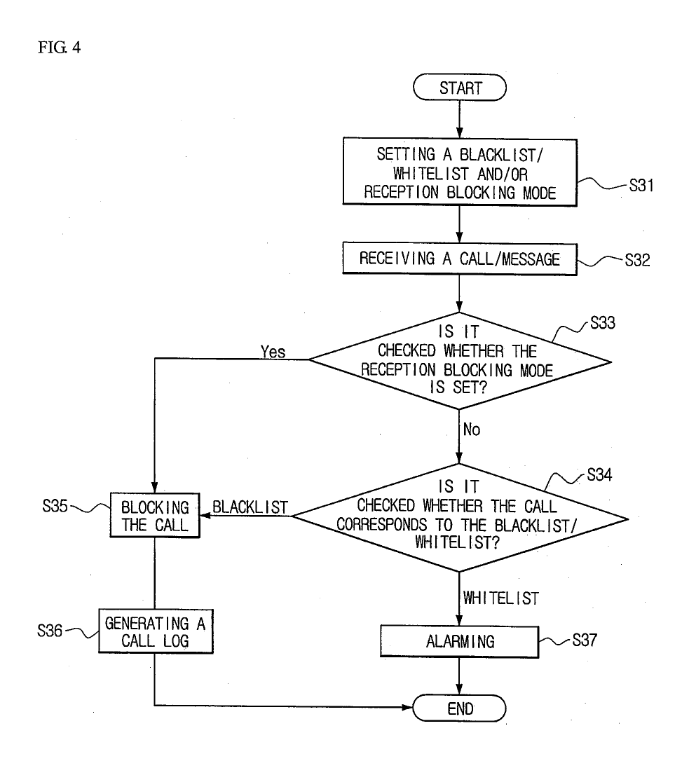

FIG. 4 is a flow chart showing a process of managing a spam according to an embodiment of the invention.

First, a user sets a blacklist/whitelist and/or reception blocking mode (any time zone at which a call is blocked) through the user interface 10 (S31). Then, when the spam management unit 41 receives a call or message through the spam message transmitting/receiving unit 42 (S32), it checks whether a reception blocking mode is set or not, i.e., whether reception time of the call is within any time zone set by the user (S33). When the reception time is within the time zone, the spam management unit 41 discourages the user agent 100 from giving an alarm for the call, immediately blocks the call (S35) and generates a log for the call (S36) so that the user can check the call reception and the blocking. To the contrary, when a reception blocking mode is not set or when the reception time is not within the time zone set by the user, the spam management unit 41 checks whether the call corresponds to the blacklist or whitelist set by the user (S34). When the call is classified as the blacklist, the spam management unit discourages the user agent 100 from giving an alarm for the call, immediately blocks the call (S35) and generates a log for the call (S36). To the contrary, when the call is classified as the whitelist, the spam management unit encourages the user agent 100 to give an alarm for the call (S37), thereby notifying the user of the call reception.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A user agent providing secure VoIP communication comprising:
a user interface that enables a user to operate the user agent to communicate with another user agent;
a signaling processing module for controlling a signaling for initiating the communication with the another user agent, which when there is a request for encryption call from a user, determines a signaling security mechanism through negotiations with an external server, encrypts a signaling message in accordance with the determined security mechanism, transmits the encrypted message to the another user agent and receives and analyzes an encrypted signaling message from the another user agent; and
a media processing module for supporting secure communication with the another user agent, which when there is a request for encryption call from the signaling processing module, generates an encryption key, determines a media encryption algorithm through negotiations with the another user agent, encrypts a voice packet generated from a voice signal of the user, transmits the encrypted packet to the another user agent and receives and decrypts an encrypted voice packet from the another user agent.

2. The user agent according to claim 1, wherein the signaling processing module comprises:
a signaling control unit that analyzes a signaling message transmitted and received between the another user agent, requests a signaling security mechanism negotiation unit to negotiate for a security mechanism when there is a request for encryption call from a user and requests a signaling generation unit to generate a signaling message when there is no request for encryption call;
a signaling security mechanism negotiation unit that when the request for encryption call is received from the signaling control unit, generates a negotiation message using a security mechanism supported by the user agent, transmits the negotiation message to an external server, analyzes a response message received from the external server to compare with the security mechanism supported by the user agent, negotiates with the external server for a security mechanism common to the external server and the user agent and requests a signaling generation unit to generate a signaling message;
a signaling generation unit that generates a signaling message in accordance with the request for signaling generation received from the signaling control unit or the signaling security mechanism negotiation unit, requests a signaling encryption/decryption unit to encrypt the signaling message and transmits the signaling message received from the signaling encryption/decryption unit to the signaling control unit when there is the request for encryption call, and requests a signaling message transmitting/receiving unit to transmit the signaling message to the another user agent and transmits the signaling message received from the another user agent to the signaling control unit when there is no request for encryption call;
a signaling encryption/decryption unit that encrypts the signaling message through the security mechanism negotiated by the signaling security mechanism negotiation unit in accordance with the request for the signaling message encryption received from the signaling generation unit, requests the signaling message transmitting/receiving unit to transmit the encrypted signaling message to the another user agent, and when encrypted signaling message is received from the another user agent, decrypts the encrypted signaling message and then transmits the decrypted signaling message to the signaling generation unit; and
a signaling message transmitting/receiving unit that transmits and receives the signaling message to and from the another user agent.

3. The user agent according to claim 2, wherein when there are two or more security mechanisms common to the external server and the user agent, the signaling security mechanism negotiation unit determines a security mechanism having a higher priority in accordance with a security policy of the user agent.

4. The user agent according to claim 1, wherein the media processing module comprises:
a media control unit that analyzes a voice signal of a user received from the user interface, requests a media encryption key management and encryption algorithm negotiation unit to generate an encryption key and to negotiate for an encryption algorithm when there is a request for encryption call from the signaling processing module and requests a media generation unit to generate a media message when there is no request for encryption call, and transmits a voice signal received from the another user agent to the user agent;
a media encryption key management and encryption algorithm negotiation unit that when the request for encryption call is received from the media control unit, generates an encryption key, transmits to the another user agent a negotiation message generated with an encryption algorithm supported by the user agent, analyzes a response message received from the another user agent to compare with the encryption algorithm supported by the user agent, negotiates with the another user agent for an encryption algorithm common to the another user agent and the user agent, and then requests a media generation unit to generate a media message;
a media generation unit that generates a voice packet from the voice signal of a user received from the media control unit, requests a media encryption/decryption unit to encrypt the voice packet and transmits the voice packet received from the media encryption/decryption unit to the media control unit when there is the request for encryption call, and requests a media message transmitting/receiving unit to transmit the voice packet to the another user agent, receives the voice packet from the another user agent and transmits the received voice packet to the media control unit when there is no request for encryption call;
a media encryption/decryption unit that encrypts the voice packet through the encryption algorithm negotiated by the encryption algorithm negotiation unit in accordance with a request for voice packet encryption received from the media generation unit, requests the media message transmitting/receiving unit to transmit the encrypted voice packet to the another user agent, decrypts the encrypted voice packet received from the another user agent and then transmits the decrypted voice packet to the media generation unit; and
a media message transmitting/receiving unit that transmits and receives the voice packet to and from the another user agent.

5. The user agent according to claim 4, wherein when there are two or more encryption algorithms common to the another user agent and the user agent, the media encryption key management and encryption algorithm negotiation unit determines a security mechanism having a higher priority in accordance with a security policy of the user agent.

6. The user agent according to claim 1, further comprising a spam processing module that manages a blacklist/whitelist so as to block a spam message or call and blocks call reception at any time zone set by a user.

7. The user agent according to claim 6, wherein the spam processing module manages the blacklist/whitelist set by a user, when a message or call corresponding to the blacklist is received, discourages the user agent from giving an alarm, blocks the message or call and generates a log for the message or call, and when a message or call corresponding to the whitelist is received, encourages the user agent to give an alarm.

8. A signaling security mechanism negotiation method using a user agent providing secure VoIP communication, the method comprising the steps of:
(a) generating, at a signaling security mechanism negotiation unit, a negotiation message using a security mechanism supported by the user agent in accordance with a request for encryption call received from a signaling control unit;
(b) transmitting, at the signaling security message negotiation unit, the negotiation message to an external server through a signaling message transmitting/receiving unit;
(c) analyzing, at the signaling security mechanism negotiation unit, a response message received from the external server through the signaling message transmitting/receiving unit; and
(d) negotiating, at the signaling security mechanism negotiation unit, with the external server for a security mechanism common to the external server and the user agent.

9. The method according to claim 8, wherein at the step of (d) comprises the step of determining a security mechanism having a higher priority in accordance with a security policy of the user agent when there are two or more security mechanisms common to the external server and the user agent.

10. A media encryption algorithm negotiation method using a user agent providing secure VoIP communication, the method comprising the steps of:
(a) generating, at a media encryption key management and encryption algorithm negotiation unit, an encryption key and a negotiation message using an encryption algorithm supported by the user agent, in accordance with a request for encryption call received from a media control unit;
(b) transmitting, at the media encryption key management and encryption algorithm negotiation unit, the encryption key and the negotiation message to a receive-side user agent;
(c) analyzing, at the media encryption key management and encryption algorithm negotiation unit, a response message received from the receive-side user agent; and
(d) negotiating, at the media encryption key management and encryption algorithm negotiation unit, with the receive-side user agent for an encryption algorithm common to the receive-side user agent.

11. The method according to claim 10, wherein at the step of (d) comprises the step of determining a security mechanism having a higher priority in accordance with a security policy of the user agent when there are two or more security mechanisms common to the receive-side user agent and the user agent.
